(19) United States
(12) Patent Application Publication
(10) Pub. No.: US 2026/0091469 A1
(43) Pub. Date: Apr. 2, 2026

(54) CONDUIT LOCKNUT TOOL

(71) Applicant: JS Products Inc., Las Vegas, NV (US)

(72) Inventor: Chungen Chen, Las Vegas, NV (US)

(21) Appl. No.: 19/341,310

(22) Filed: Sep. 26, 2025

Related U.S. Application Data
(60) Provisional application No. 63/701,344, filed on Sep. 30, 2024.

(51) Int. Cl. B25B 13/50; B25B 13/48; B25B 23/00

(52) U.S. Cl. CPC B25B 13/50; B25B 13/481; B25B 23/0028

(57) ABSTRACT

A locknut wrench for tightening and loosening a locknut is provided. The locknut wrench has a handle which is coupled to a pair of locknut engaging tangs, such as via an interconnect member. The handle is angularly adjustable relative to the tangs, such as to be orientated perpendicular to a plane containing the tangs or parallel to a plane containing the tangs. The locknut wrench can also be placed into either a first or second mode of operation, such as corresponding to tightening or loosening a locknut, wherein in the different modes a different tang is locked relative to the handle.

### RELATED APPLICATION DATA

The present application claims priority to U.S. Provisional Application Ser. No. 63/701,344, filed Sep. 30, 2024, which prior application is incorporated by reference in its entirety herein.

### FIELD OF THE INVENTION

The present invention relates to wrenches, and particularly conduit locknut tools.

### BACKGROUND OF THE INVENTION

Traditional locknut wrenches have numerous shortcomings. For example, it is common that users often need multiple different wrenches in order to work on different locknut sizes (e.g., ½ inch, ¾ inch, and 1 inch). Furthermore, locknut wrenches typically have two wrench ends, one for tightening and another for loosening, requiring users to swap ends back and forth. Finally, typical locknut wrenches are not designed to work with locknuts that are mounted on a bottom inside face of a junction box, given that the tool must generally be placed parallel to the nut, which is prevented by the sides of the junction box.

It is with respect to these and other considerations that the instant disclosure is concerned.

### SUMMARY OF THE INVENTION

One aspect of the invention comprises a locknut wrench for tightening and loosening a locknut, such as for engagement or disengagement of the locknut with a conduit, and a method of using a locknut wrench.

In one embodiment, the locknut wrench has a handle which is coupled to a pair of locknut engaging tangs. The handle is angularly adjustable relative to the tangs, such as to be orientated perpendicular to a plane containing the tangs or parallel to a plane containing the tangs. The locknut wrench can also be placed into either a first or second mode of operation, such as corresponding to tightening or loosening a locknut, wherein in the different modes a different tang is locked relative to the handle.

In one embodiment, the locknut wrench may comprise a handle, an interconnect member coupled to the body, a first locknut engaging tang and a second locknut engaging tang each rotatably mounted to the interconnect member, and a locking member associated with the interconnect member and configured to selectively move between a tightening position corresponding to the locking member engaging the first tang, but not the second tang, in order to allow the locknut to be tightened via rotation of the handle, and a second position corresponding to the locking member engaging the second tang, but not the first tang, in order to allow the locknut to be loosened via rotation of the handle.

The example locknut wrench may be configured for vertical insertion into a junction box, that is, with a handle positioned vertical with respect to a bottom wall of the junction box. The handle may also be position adjustable, such as relative to the interconnect member, such that it can pivot 90 degrees clockwise or counterclockwise, thus allowing locknuts to be removed from conduits when the locknuts are accessible in a multitude of different configurations.

In one example tangs of the locknut wrench are biased towards one another, thus allowing the locknut wrench to be employed with a plurality of different sized locknuts.

Further objects, features, and advantages of the present invention over the prior art will become apparent from the detailed description of the drawings which follows, when considered with the attached figures.

### DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an isometric view of a locknut wrench, shown as employed with a portion of a junction box, in accordance with one non-limiting embodiment of the disclosed concept.

FIGS. 2 and 3 show front and rear exploded isometric views, respectively, of the locknut wrench of FIG. 1.

FIGS. 4 and 5 show front and rear exploded isometric views, respectively, of portions of the locknut wrench of FIG. 1.

FIGS. 6 and 7 show front and rear isometric views, respectively, of a portion of the locknut wrench of FIG. 1.

FIG. 8 shows another rear isometric view of the portion of the locknut wrench of FIG. 7, shown with a locking bar in a different position, as compared to FIG. 7.

FIG. 9 is a top view of the locknut wrench of FIG. 1.

FIG. 10 is a section view of the locknut wrench of FIG. 9, taken along line 10-10 of FIG. 9.

FIG. 11 shows an isometric view of the locknut wrench of FIG. 1, shown with a handle pivoted 90 degrees from the position depicted in FIG. 1.

FIG. 12 shows another isometric view of the locknut wrench of FIG. 11, shown with the handle pivoted 180 degrees from the position depicted in FIG. 11.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

As employed herein, the term “coupled” shall mean connected together either directly or via one or more intermediate parts or components.

As employed herein, the term “number” shall mean one or an integer greater than one (i.e., a plurality).

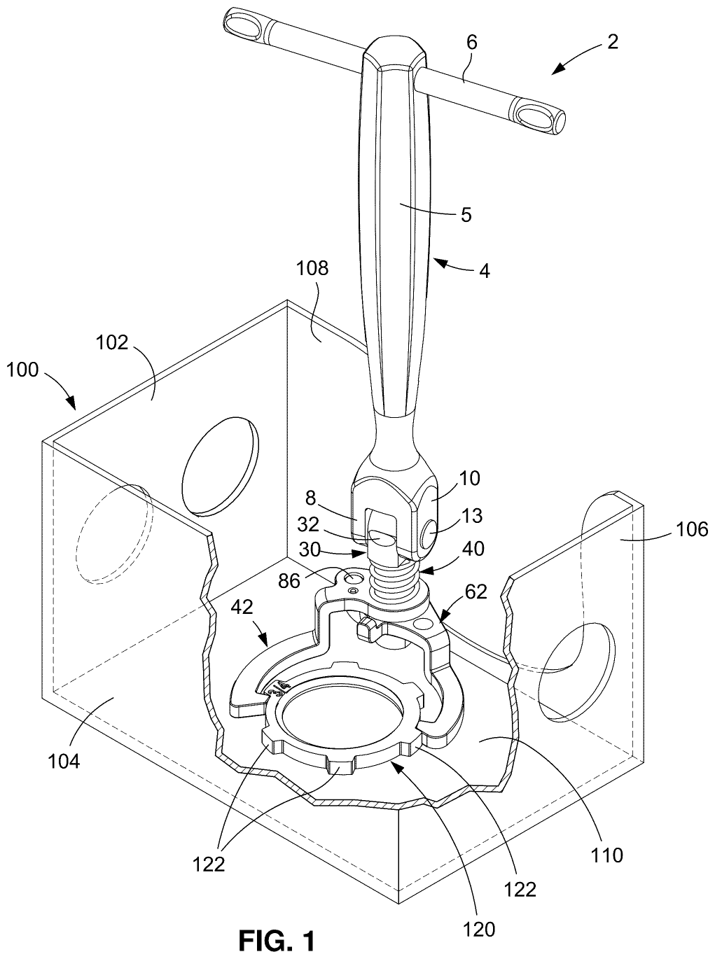

FIG. 1 shows a conduit locking tool (e.g., locknut wrench 2) as employed with a portion of a junction box 100. The junction box 100 includes a number of walls 102 and 104 and 106 and 108 and 110 that together define an interior, wherein located on a first wall 110 in the interior is a locknut 120. It will be appreciated that the locknut 120 may be coupled (e.g., threadably coupled) to a suitable conduit. In accordance with the disclosed concept, the locknut wrench 2 is advantageously structured to selectively de-couple the locknut 120 from, and couple the locknut 120 to, the conduit in a desirable manner (e.g., can be used to tighten and loosen the locknut 120).

In one example, the locknut wrench 2 includes a main handle 4 and a pair of selectable tangs 42 and 62 coupled to the main handle 4. As will be discussed below, the tangs 42 and 62 are together configured to engage or grip the locknut 120 at teeth or extension portions 122 of the locknut 120. Responsive to rotation of the main handle 4 (generally in a counter-clockwise direction), the tangs 42 and 62 are configured to de-couple the locknut 120 from the conduit (not shown in FIG. 1), and also tighten (when the main handle 4 is turned in a clockwise direction) the locknut 120 to the conduit. In this manner, the tangs 42 and 62 are selectable such that a user can, as will be discussed below, move the locknut wrench 2 between two different positions each corresponding to one of the two tangs 42 and 62 being employed to drive motion.

Moreover, the main handle 4 preferably includes an elongated body 5 and may include a grip or similar element which is associated with the elongate body 5 for use in aiding the user in turning the handle 4. As illustrated, this grip may comprise a rod or pin member 6 coupled to the body 5 and which extending generally perpendicular thereto, to allow a user to better grip the main handle 4.

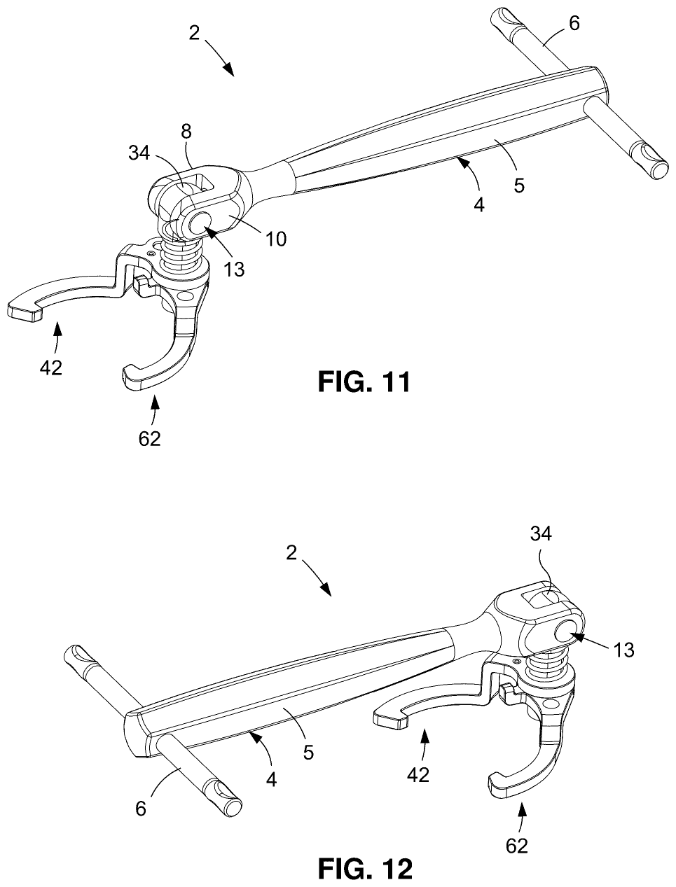

In the example of FIG. 1, the elongated body 5 is configured perpendicular with respect to the lower wall 110 of the junction box 100, thus allowing for the locknut 120 to be removed from the junction box 100 when mounted on the lower wall 110. This capability of the locknut wrench 2 provides a tremendous improvement over today's art, which is not designed to work with locknuts mounted on a bottom inside face of a junction box. Moreover, while in one embodiment the locknut wrench 2 may be oriented so that the main handle 4 extends perpendicular to a plane containing the tangs 42 and 62, and thus a plan containing a locknut 120, in a preferred configuration, the locknut wrench 2 permits the main handle 4 to be placed in other orientations, such as illustrated in FIGS. 11 and 12, wherein the elongated body 5 has been pivoted 90 degrees in two different directions (e.g., FIGS. 11 and 12) so that it extends in a plane which is generally parallel to the tangs 42 and 62 and thus parallel to a plane containing a locknut 120, such as to allow the locknut wrench 2 to remove a locknut from the junction box 100 in two other orientations with respect to the junction box 100. Accordingly, it will be appreciated that in one embodiment, the main handle 4 is position adjustable in order to allow locknuts to be gripped, and tightened or loosened regardless of their position in a junction box.

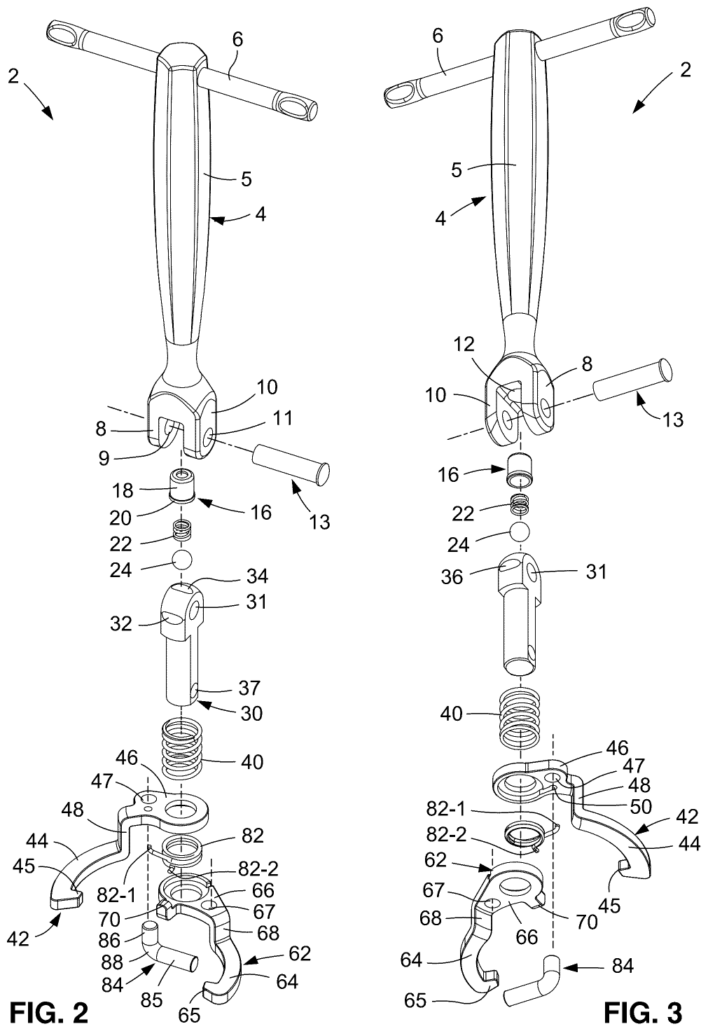

FIGS. 2 and 3 show different exploded views of the locknut wrench 2. As shown, in addition to the main handle 4 and the tangs 42 and 62, the locknut wrench further includes another pin member 13, a retaining member 16, a biasing element (e.g., spring 22), a bearing 24, an interconnect member 30, a number of other biasing elements (e.g., springs 40 and 82), and a locking bar 84. Preferably, these components together allow the locknut wrench 2 to tighten and loosen the locknut 120 (FIG. 1) when in a plurality of different configurations with respect to a junction box.

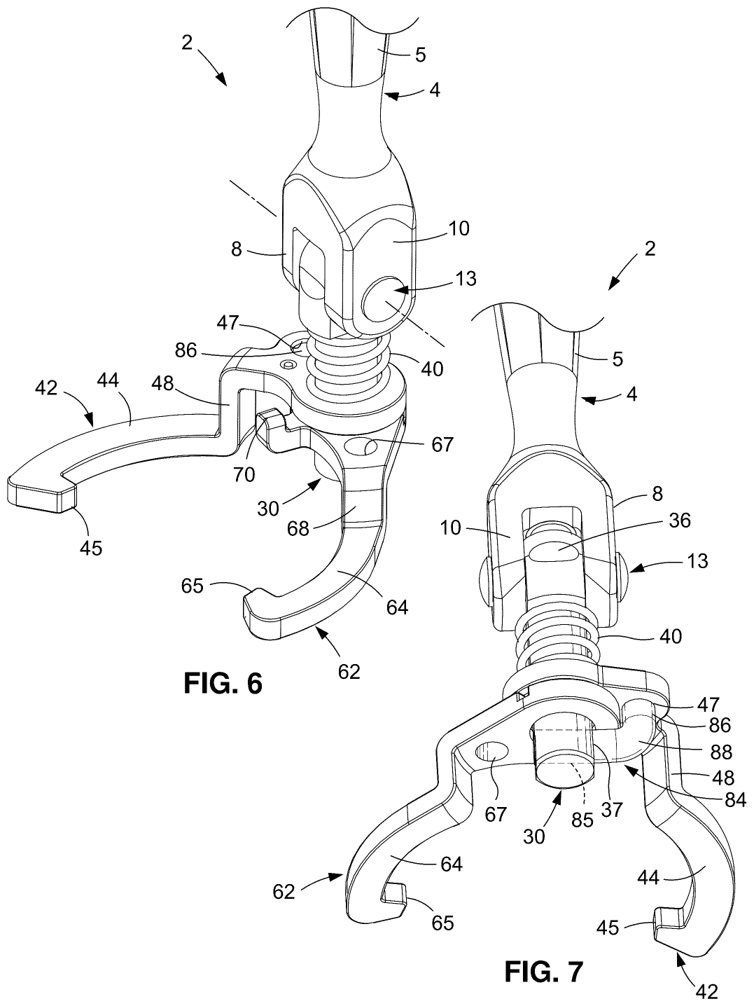

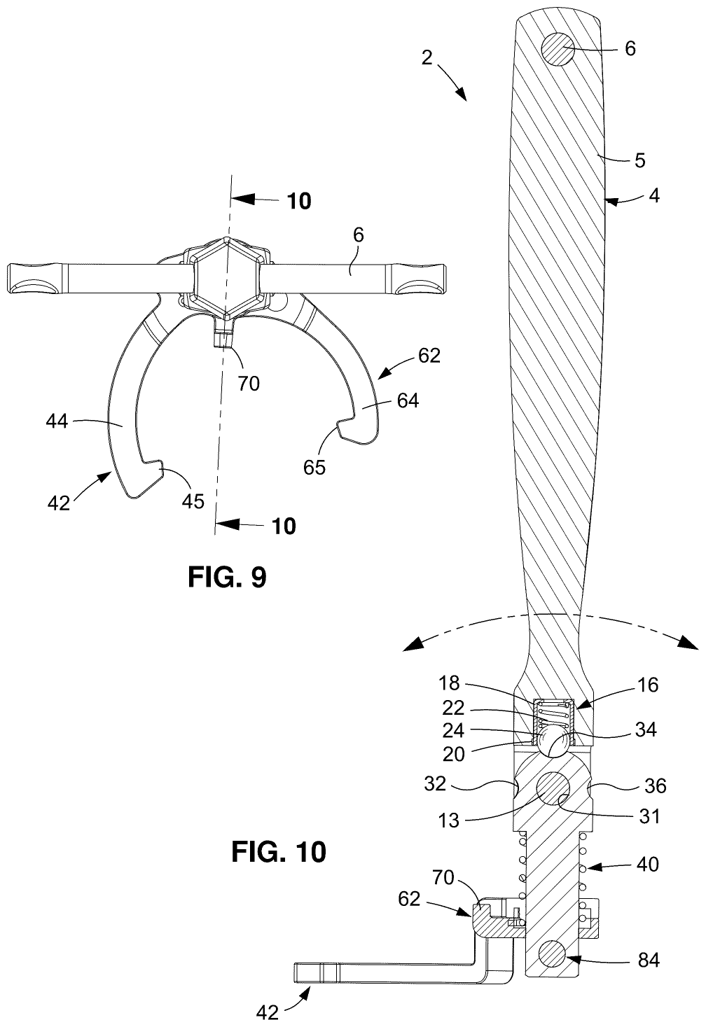

Referring to FIGS. 1-10, the manner in which the aforementioned components are coupled and configured will be discussed. As shown in FIGS. 2 and 3, the retaining member 16 has a tubular-shaped portion 18 and a flange portion 20 extending outwardly from an end of the retaining member 16. The tubular-shaped portion 18 is configured to be located in a rear opening 12 of an end of the elongated body 5, and the spring 22 is configured to be located internal with respect to the tubular-shaped portion 18. See, for example, the section view of FIG. 10.

Continuing to refer to FIG. 10, the bearing 24, which may be spherical-shaped, is configured to engage each of the spring 22 and the interconnect member 30. More particularly, the interconnect member 30 preferably has a plurality of detent regions 32 and 34 and 36 that are each configured to maintain a position of the bearing 24 with the spring, and lock the main handle 4 into one of the designated positions.

For example, as shown in FIG. 10, the bearing 24 is located in the second detent region 34, which maintains the elongated body 5 at a 180-degree orientation with respect to the interconnect member 30. If a user desires to orient the elongated body 5 at 90-degree orientations with respect to the interconnect member (e.g., FIGS. 11 and 12), all the user has to do is press down on the main handle 4, which will cause the bearing 24 to move upwardly with respect to the interconnect member 30, and pivot the main handle 4 left or right, with reference to FIG. 10. As the main handle 4 is pivoting toward one of the other detent regions 32 and 36, the bearing 24 will be compressed up into the spring 22 in order to allow the elongated body 5 to pivot. After pivoting, the bearing 24 will “pop” into a corresponding one of the other detent regions 32 and 36, thus locking the main handle 4 in place with respect to the interconnect member 30. Moreover, the pin member 13 preferably extends through thru holes 9 and 11 of end portions 8 and 10 of the elongated body 5, as well as through a thru hole 31 of the interconnect member 30 in order to facilitate a rotational coupling between the interconnect member 30 and the elongated body 5.

In the embodiment illustrated, the locknut wrench 2 is configured to be moved to three different angular positions which are 90 degrees from one another, and thus has three corresponding detent regions. In other embodiments, the locknut wrench 2 might have other configurations, such as other or additional detent positions.

Referring again to FIGS. 2 and 3, in addition to having the main handle 4 be able to pivot and be maintained in a plurality of different angular positions (such as relative to a plane containing the tangs 42 and 62), the locknut wrench 2 is advantageously configured to be selectively configured into different modes, such as a first mode for loosening a lock nut and a second mode for tightening a locknut.

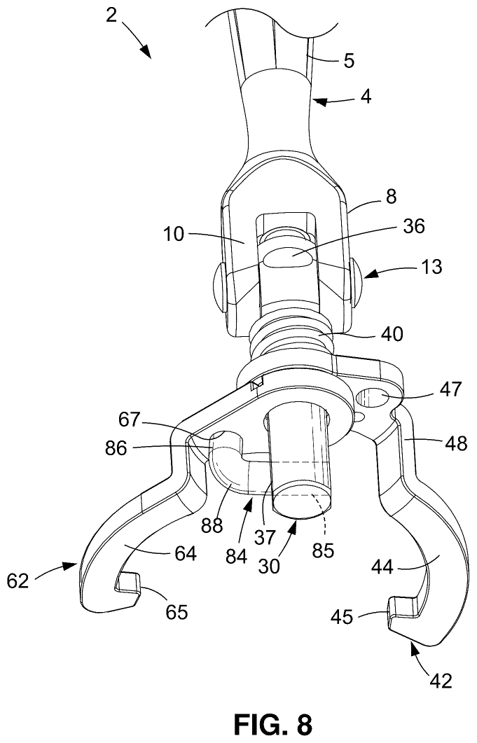

In order to perform this function, as shown, the interconnect member 30 preferably extends through both of the springs 40 and 82, as well as through both of the tangs 42 and 62. Furthermore, shown most clearly in FIGS. 7 and 8, the locking bar 84 is associated with (e.g., coupled to or formed as a unitary component optionally made from one single piece of material) the interconnect member 30. In the example of FIGS. 7 and 8, the locking bar 84 extends at least partially through a thru hole 37 of the interconnect member 30. The configuration of the locking bar 84 advantageously allows the single locknut wrench 2 to have different modes for both tightening and loosening locknuts.

More specifically, and with reference again to FIGS. 2 and 3, each of the tangs 42 and 62 preferably include a gripping portion 44 and 64, an interconnect portion 46 and 66, and a joining portion 48 and 68 extending therebetween. In one example, the gripping portions 44 and 64 each include corresponding hook portions 45 and 65 (such as configured as inwardly extending prongs or tabs) at distal ends thereof for engaging the teeth 122 (FIG. 1) of the locknut 120. The interconnect portions 46 and 66 each preferably include a corresponding opening (e.g., without limitation, thru hole 47 and 67), and these thru holes 47 and 67 are configured to receive the locking bar 84.

Continuing to refer to FIGS. 2 and 3, the locking bar 84 preferably includes a first segment 85, a second segment 86 optionally located perpendicular to the first segment 85, and bend portion 88 extending therebetween. The first segment 85 may be configured to extend at least partially through the thru hole 37 of the interconnect member 30, and the second segment 86 may be configured to extend into both of the thru holes 47 and 67. More specifically, if a user desires to move between a tightening configuration and loosening configuration, all the user needs to do is cause the second segment 86 of the locking bar 84 to move between a first position corresponding to extending at least partially into the thru hole 47 of the first tang 42 to a second position corresponding to extending at least partially into the thru hole 67 of the second tang 62.

In order to effectuate this movement, the user needs to press main handle 4 down, so that the interconnect member 30 compresses the spring 40 towards the interconnect portion 46 of the first tang 42. As this is happening, the locking bar 84, which is coupled to or extending from an opposite end of the interconnect member 30, also moves down such that the second segment 86 no longer extends into a corresponding one of the thru holes 47 and 67. When the locking bar 84 is in this position, a simple rotation of the main handle 4 by a user will cause the interconnect member 30, and thus the locking bar 84, to move to a second position. Upon reaching the second position, when the user ceases to press down on the main handle 4, the spring 40 will drive the interconnect member 30 up, and at the same time cause the second segment 86 of the locking bar 84 to extend at least partially into a different one of the thru holes 47 and 67. Accordingly, the movement of the locking bar 84 between first and second positions, as caused by the main handle 4 compressing the spring 40, advantageously allows the locknut wrench 2 to be used to both tighten and loosen the locknut 120 (FIG. 1).

To illustrate, as shown in FIG. 7, the second segment 86 extends at least partially into the thru hole 47 of the first tang 42. This locks the position of the first tang 42 to the main handle 4 (the second tang 62 is not locked, but can move a limited distance (as limited by a stop 70 as detailed below). This position corresponds to a tightening position of the locknut wrench 2. If a user desires to move to a loosening position, all the user needs to do is move the second segment 86 to the thru hole 67 of the second tang 62, as described above and as illustrated in FIG. 8. At that time, the second tang 62 is locked to the main handle 4, but the first tang 62 is not.

It is also contemplated that the first and second tangs 42 and 62 are configured to be biased toward a closed position corresponding to tight-fitting engagement with the locknut 120 (FIG. 1). More specifically, as shown in FIGS. 2-5, the spring 82 has a first end 82-1 and a second, opposite end 82-2. Moreover, the spring 82 is configured to be located between each of the interconnect portions 46 and 66 in a manner wherein the first end 82-1 is preferably located in a locking groove 50 of a bottom-facing surface of the first tang 42, and the second end 82-2 is located in a recessed portion of a top-facing surface of the second tang 62 and an associated locking groove 51.

Alternate engagement configurations of a spring with respect to tangs are contemplated herein. However, these two engagements preferably cause the first and second tangs 42 and 62 to be biased toward a closed position such that when a user desires to tighten or loosen the locknut 120 (FIG. 1), the user can simply locate the first and second tangs 42 and 62 around the locknut 120, and the spring 82 will pull the tangs 42 and 62 into a tight-fitting engagement with the locknut 120. This advantageously simplifies the ability of users to secure the locknut wrench 2 to locknuts. Moreover, by employing the spring 82 causing the tangs 42 and 62 to be biased toward a closed position, the locknut wrench 2 auto-fits onto any of a plurality of common locknut sizes (e.g., ½ inch, ¾ inch, and 1 inch).

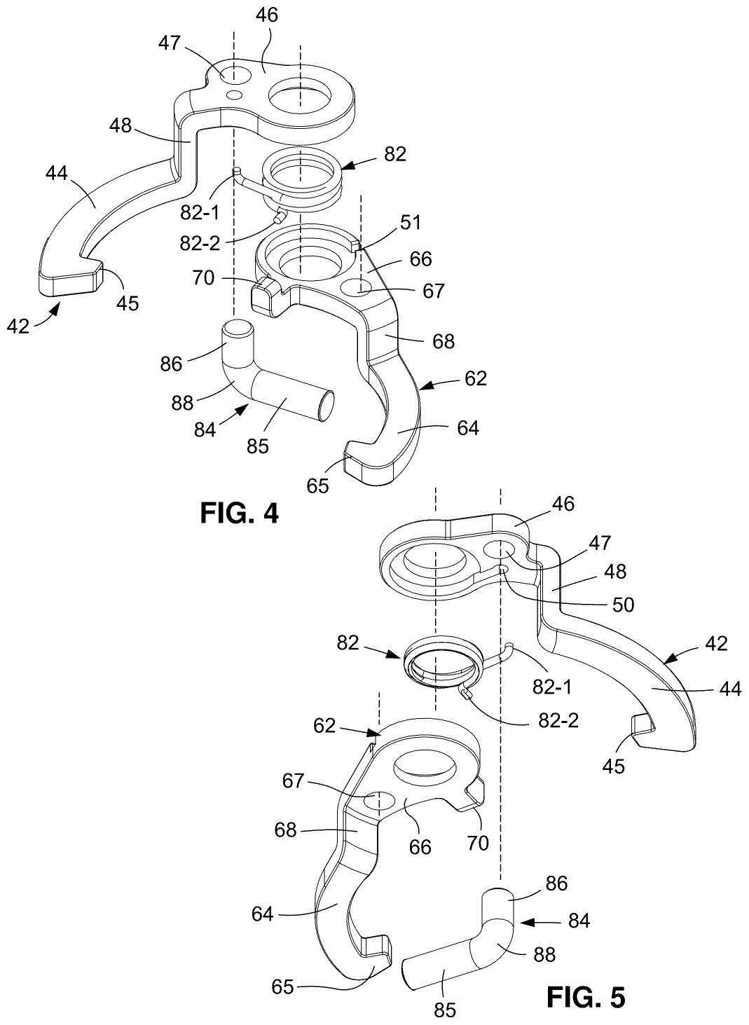

As indicated above, in one configuration, in each mode of operation one tang 42 and 62 is locked to the main handle 4, while the other tang is permitted to rotate. In one embodiment, however, rotation of the “free” tang is limited, such as a by a stop 70. As illustrated, the stop 70 may be a body (such as an extension) which extends outwardly from one of the tangs 42 and 62, such as the second tang 62 as illustrated in FIG. 4. In the embodiment illustrated, the stop 70 may extend outwardly and upwardly from the interconnect portion 66 of the second tang 62, preferably between the first and second tangs, so that rotation of the first and second tangs 42 and 62 towards one another is limited by contact of the stop 70 with the first tang 42.

Other configurations of the invention are contemplated. For example, while in one embodiment each tang 42 and 62 may include a single prong 45 and 65, such as at a free end of the tang, the prongs might be located in different positions or the tangs might include multiple prongs.

As indicated above, in a preferred embodiment the main handle can be placed in different orientations relative to a plane containing the tangs, such as three angular positions 90 degrees from one another. Other positioning mechanisms may be utilized other than the one described above. For example, in one embodiment, the interconnect member 30 might define passages therethrough for receiving a locking pin which passes through elongated body 5 and into one of the passage for locking the angular position of the main handle 4.

In one embodiment, the locknut wrench 4 includes a selector for selectively engaging the tangs in a first mode or a second mode (such as in tightening and loosening modes). As described above, that selector may comprise a locking bar 84 which is associated with the main handle 4 (indirectly via the interconnect member 30). However, other selector mechanisms might be utilized.

Aspects of the invention comprise a method of operating a locknut wrench 2 in order to tighten or loosen a locknut 120, such as including the step of angularly positioning the main handle 4 to a desired position and selectively locking one of the tangs 42 and 62 to engage a first or second mode of operation of the wrench 2, and then turning the main handle 4.

It will be understood that the above-described arrangements of apparatus are merely illustrative of applications of the principles of this invention and many other embodiments and modifications may be made without departing from the spirit and scope of the invention as defined in the claims.

What is claimed is:

1. A locknut wrench for tightening and loosening a locknut, comprising:
a handle;
an interconnect member pivotally coupled to the handle; and
a first locknut engaging tang and a second locknut engaging tang each rotatably mounted on the interconnect member;
said handle movable between a first position in which it extends along said axis of said interconnect member and a second position in which it extends perpendicular to said axis of said interconnect member.

2. The locknut wrench in accordance with claim 1, wherein said first locknut engaging tang has a first end and a second end, said first end of said first locknut engaging tang mounted to said interconnect member and said second end located outwardly of said interconnect member.

3. The locknut wrench in accordance with claim 2, wherein said second locknut engaging tang has a first end and a second end, said first end of said second locknut engaging tang mounted to said interconnect member and said second end located outwardly of said interconnect member.

4. The locknut wrench in accordance with claim 3, further comprising at least one biasing member which biases said second ends of said first and second locknut engaging tangs towards one another.

5. The locknut wrench in accordance with claim 4, wherein said at least one biasing member comprises a spring mounted on said interconnect member and engaging both said first and second locknut engaging tangs.

6. The locknut wrench in accordance with claim 5, wherein said first and second locknut engaging tangs are pivotally movable away from one another relative to said interconnect member against a biasing force generated by said at least one biasing member.

7. The locknut wrench in accordance with claim 4, further comprising a stop mounted on at least one of said first and second locknut engaging tags which limits movement of said first and second locknut engaging tangs towards one another.

8. The locknut wrench in accordance with claim 5, wherein said spring defines a passage and said interconnect member extends through said passage.

9. The locknut wrench in accordance with claim 1, further comprising a locking bar extending from the interconnect member and configured to engage either said first locknut engaging tang or said second locknut engaging tang.

10. The locknut wrench in accordance with claim 9, wherein said interconnect member is movable axially relative to said first and second locknut engaging tangs from a first position in which said locking bar engages one of said tangs and a second position in which said locking bar is disengaged from said tangs.

11. The locknut wrench in accordance with claim 10, further comprising a biasing member positioned between said handle and said first locknut engaging tang.

12. The locknut wrench in accordance with claim 11, where said biasing member comprises a spring having a passage, at least a portion of said interconnect member located in said passage.

13. The locknut wrench in accordance with claim 10, wherein said interconnect member and said locking bar are movable downwardly relative to said first and second locknut engaging tangs by application of a downward force on said handle.

14. The locknut wrench in accordance with claim 10, wherein said locking bar has a second end spaced from said interconnect member and each of said first and second locknut engaging tangs comprises an aperture for accepting said second end of said locking bar.

15. The locknut wrench in accordance with claim 1, wherein a first tab extends outwardly from said first locknut engaging tang towards said second locknut engaging tang and second tab extends outwardly from said second locknut engaging tang towards said first locknut engaging tang.

16. A locknut wrench for tightening and loosening an engagement between a locknut and a conduit, comprising:
a handle;
an interconnect member pivotally coupled to the handle;
a first locknut engaging tang and a second locknut engaging tang each having a first end rotatably mounted on the interconnect member and a second end located outwardly of said interconnect member and having a locknut engaging tab thereon, said first and second locknut engaging tangs biased towards one another; and
a locking member extending from said interconnect member and selectively engageable with either said first locknut engaging tang or said second locknut engaging tang, said locking member when engaging said first locknut engaging tang preventing rotation of said first locknut engaging tang relative to said interconnect member but permitting said second locknut engaging tang to rotate relative to said interconnect member, and said locking member when engaging said second locknut engaging tang preventing rotation of said second locking engaging tang relative to said interconnect member but permitting said first locknut engaging tang to rotate relative to said interconnect member;
said handle movable between a first position in which it extends along said axis of said interconnect member and a second position in which it extends perpendicular to said axis of said interconnect member.

17. The locknut wrench in accordance with claim 16, wherein said interconnect member is movable axially relative to said first and second locknut engaging tangs from a first position in which said locking bar engages one of said tangs and a second position in which said locking member is disengaged from said tangs.

18. The locknut wrench in accordance with claim 16, wherein said interconnect member has a first end and a second end, said handle connected to said first end and said first and second locknut engaging tangs mounted on said second end.
